(19) United States
(12) Patent Application Publication
(10) Pub. No.: US 2026/0223767 A1
(43) Pub. Date: Aug. 6, 2026

(54) REVERSIBLE FAN BLADE ASSEMBLY

(71) Applicant: Brinly-Hardy Company, Inc., Jeffersonville, IN (US)

(72) Inventors: Nicholas R. Carroll, Georgetown, IN (US); Scott Carpenter, New Albany, IN (US)

(21) Appl. No.: 19/046,786

(22) Filed: Feb. 6, 2025

(51) Int. Cl. A01C 17/00; B05B 3/10

(52) U.S. Cl. CPC A01C 17/001; A01C 17/005; B05B 3/1007; B05B 3/1035

(57) ABSTRACT

A reversible fan blade assembly for a broadcast spreader is provided. The assembly includes a double-sided or reversible fan that includes one or more appurtenances on each side of the fan. A first shaft couples a gearbox to the fan via a shaft boss located at a central region of the fan. The fan can be easily removed from the fan blade assembly, flipped over 180 degrees, and reinstalled to the fan blade assembly. A second, floating shaft, or alternatively a fan that is separable into pieces, can facilitate installation and removal of the fan from the assembly.

### BACKGROUND

Various devices exist for spreading or broadcasting materials such as fertilizer or grass seed onto a lawn or other area. Spreaders (whether of the drop or broadcast variety) are typically used for this purpose and can evenly distribute fertilizer and/or grass seed over a particular area. Drop spreaders distribute the material in even, accurate rows and typically cover a small area. Broadcast (rotary) spreaders distribute the material in a fan-like pattern in all directions, and therefore cover a much larger area than do drop spreaders.

Broadcast spreaders typically involve a hopper for holding a granular material, coupled to drive wheels that traverse across a surface. The drive wheels are coupled to a transmission that converts horizontal rotational movement into vertical rotational movement. A vertical shaft is connected to a fan blade, which is below an opening in the hopper, that rotates with the vertical shaft. As the fan blade spins, it helps distribute granular material that falls onto the fan blade from the hopper opening. The fan blade typically includes some structure, such as ridges or walls, to help distribute the granular material.

The fan blades wear out over time due to age. The fan blades also wear out due to prolonged abrasive wear from the various types of granular materials spread by the spreader. Currently, replacing the fan blade is a complicated and tedious task. Depending on the type of spreader, the process involves one of three methods. In spreaders where the gearbox comprises two halves, the user must disassemble the gearbox and remove the fan shaft by pulling it out from the bottom of the hopper in order to separate the fan shaft from the hopper. In spreaders that have a gearbox that is not two halves, a user must remove the wheel axle and pull the entire gearbox out from beneath the hopper. A third approach is for the user to remove the hopper entirely from the spreader in order to separate the fan shaft from the hopper. After the fan shaft has been removed from the hopper, a new fan blade must be installed using the same process in reverse. An additional problem is that users go through all this trouble to replace a fan, despite the fact that only one side of the fan blade has experienced any significant wear.

A need exists for an apparatus for more quickly and more simply replacing a fan blade of a broadcast spreader. A need also exists for a fan blade that has longer usable life because it is double-sided.

### SUMMARY

The following disclosed system, components, and methods facilitate the easy and rapid replacement of a fan blade assembly in a broadcast spreader and create a longer lifespan for same. The herein-described embodiments additionally address the problems in the art associated with short life spans of fan blades.

In an embodiment, a fan blade assembly is provided comprising a fan having a central region, a first side, and a second side. The first side includes one or more appurtenances thereon extending away from the first side, and the second side includes one or more appurtenances thereon extending away from said the side. A shaft boss is located at the central region of the fan, and the shaft boss has a generally cylindrical shape with a length between a first end of the shaft boss and a second end of the shaft boss. The shaft boss also includes an outer surface and a shaft opening therein, the shaft opening being configured to receive therewithin one or more shafts. A first shaft having a first end and a second end is also provided, wherein the first end is coupled within a gearbox and the second end is configured to be disposed within the shaft opening.

In an embodiment, a fan blade assembly is provided comprising: a fan having a central region, a first side, and a second side. The first side includes one or more appurtenances thereon extending away from the first side, and the second side includes one or more appurtenances thereon extending away from the second side. A first shaft is provided that has a first end and a second end, the first end being coupled within a gearbox. A second shaft is provided that has a first end and a second end, wherein the second end of the second shaft is configured to be freely received within a hopper of a spreader. A shaft boss located at the central region of the fan, the shaft boss having a generally cylindrical shape with a length between a first end of the shaft boss and a second end of the shaft boss, an outer surface and a shaft opening therein. The shaft opening is configured to receive therewithin the second end of the first shaft, and to receive the first end of the second shaft collinear with the first shaft. A lock is configured to couple the first shaft to the shaft boss.

In an embodiment, a method of reconfiguring a fan blade of a broadcast spreader is provided, wherein the comprises the step of providing a broadcast spreader with a fan blade assembly further comprising a fan having a first side, a second side, and a shaft boss in a central region thereof, wherein the shaft boss further comprises a shaft boss receiver; and a shaft having a receiver therein configured to receive a lock for securing the fan to the shaft; wherein the fan first side includes one or more first appurtenances and the fan second side includes one or more second appurtenances, and wherein the fan first side is facing a first direction. The method also includes the steps of removing the fan from the shaft by removing a lock from the receiver; separating the fan from the shaft; flipping the fan 180 degrees so as to make the fan first side face in a second direction opposite the first direction; inserting the shaft into the shaft boss of the fan; aligning the receiver of the shaft with the shaft boss receiver; and inserting a lock into the receiver of the shaft boss through the receiver of the shaft.

These and other advantages and features are set forth in the claims annexed hereto and forming a further part hereof. However, for a better understanding of the invention, and of the advantages and objectives attained through its use, reference should be made to the figures, and to the accompanying descriptive matter, in which there is described example embodiments of the invention. This summary is merely provided to introduce a selection of concepts that are further described below in the detailed description, and is not intended to identify key or essential features of the claimed subject matter, nor is it intended to be used as an aid in limiting the scope of the claimed subject matter.

### BRIEF DESCRIPTION OF THE DRAWINGS

FIG. 1 is a perspective view of a broadcast spreader of the walk-behind variety showing an assembly according to an embodiment of the present disclosure.

FIG. 2 is a close-up perspective view of the bottom region of the spreader according to an embodiment.

FIG. 3 is a section view taken at Section 3-3 of FIG. 2, slightly rotated from the view of FIG. 2.

FIG. 4 is an exploded view of the assembly of FIG. 2 according to an embodiment.

FIG. 5 is a cutaway view of the fan blade region according to an embodiment.

FIG. 6 is a top perspective view of a fan blade according to an embodiment.

FIG. 7 is a close-up perspective view of the bottom region of the spreader according to another embodiment.

FIG. 8 is a section view taken at Section 8-8 of FIG. 7, slightly rotated from the view of FIG. 7.

FIG. 9 is an exploded view of the assembly of FIG. 7 according to an embodiment.

FIG. 10 is a cutaway view of the fan blade region according to an embodiment.

FIG. 11 is a top perspective view of a fan blade according to an embodiment.

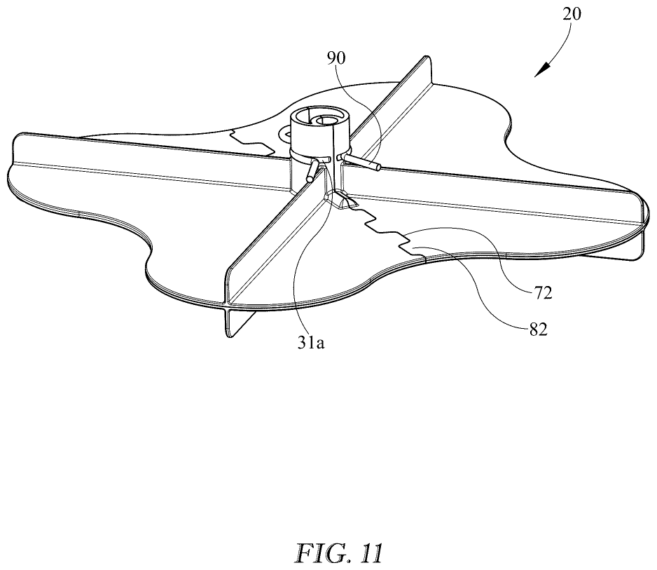

It should be understood that the drawings are not necessarily to scale and that the embodiments are sometimes illustrated by graphic symbols, phantom lines, diagrammatic representations, and fragmentary views. In certain instances, details that are not necessary for an understanding of the embodiments described and claimed herein, or which render other details difficult to perceive, may have been omitted. It should be understood, of course, that the scope of the claims is not to be limited to the particular embodiments illustrated in the figures. Indeed, it is expected that persons of ordinary skill in the art may devise a number of alternative configurations that are similar and equivalent to the embodiments shown and described herein without departing from the spirit and scope of the claims.

### DETAILED DESCRIPTION

Detailed embodiments of the present invention are disclosed herein; however, it is to be understood that the disclosed embodiments are merely illustrative of the invention that may be embodied in various forms. In addition, each of the examples given in connection with the various embodiments of the invention are intended to be illustrative, and not restrictive. Therefore, specific structural and functional details disclosed herein are not to be interpreted as limiting, but merely as a representative basis for teaching one skilled in the art to variously employ the present invention.

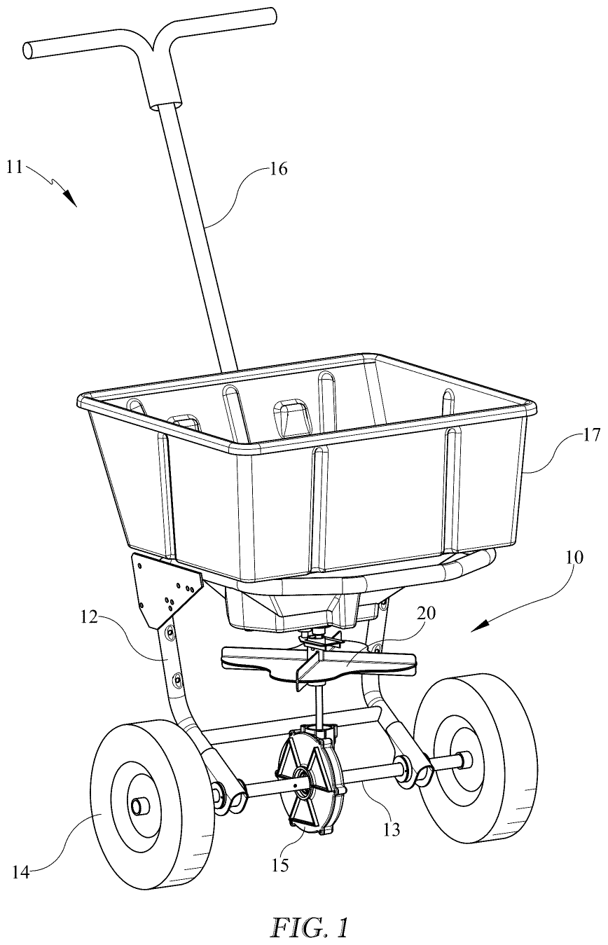

Turning now to the drawings, wherein like numbers denote like parts throughout the several views, FIG. 1 illustrates a perspective view of a spreader 11 that can utilize embodiments of the assembly described herein. A walk-behind spreader 11 is depicted, but the spreader 11 can be any type of spreader, including hand-held, tow-behind, ride-on, and the like. The spreader 11 includes a frame 12 coupled to an axle 13 on which wheels 14 are rotatably mounted for traversing across a ground surface. A handle 16 is fitted to the spreader 11 to facilitate pushing and pulling across a ground surface by a user. A hopper 17 is also fitted to the frame 12. The hopper 17 provides the containment volume for a desired amount of granular material to be spread across a ground surface. The axle 13 has a gearbox 15 that converts the rotating movement of the wheels 14 (which is an axis coincident with a longitudinal axis of the axle 13) into rotatable motion of a first shaft 40 about an shaft axis of rotation SA coincident with a longitudinal axis of the first shaft 40, which is neither coincident with nor parallel to the longitudinal axis of the axle 13. The first shaft 40 includes a first end 41 that is coupled to the gearbox 15. The first shaft 40 also includes a second end 42 that is coupled to the fan 20 via a pin-receiving hole 43, as will be described. As can be seen in the figures, the preferred angle between the longitudinal axis of the axle 13 and the longitudinal axis of the first shaft 40 is approximately 90 degrees. This is not required, however, and any angle between 0 and 90 degrees is possible.

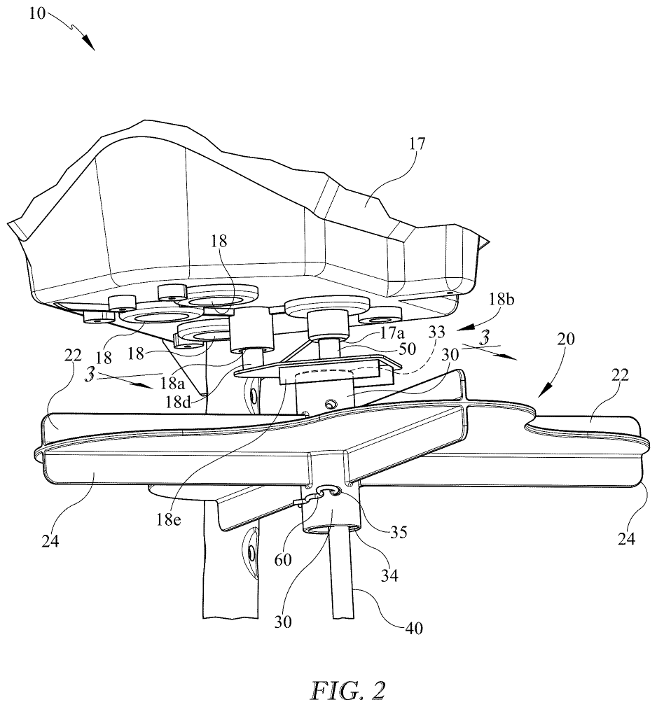

FIG. 2 is a close-up of a portion of a bottom region of the hopper 17 of spreader 11. A fan blade assembly 10 is positioned beneath the hopper 17 and above the gearbox 15. In common spreaders, the hopper 17 includes one or more openings 18 at a bottom surface thereof through which granular material may pass. A separate agitator opening 18a for an agitator can be included, if desired. If included, an agitator assembly 18b can have an agitator arm 18c coupled to an agitator shaft 18d that is received in the agitator opening 18a. The agitator shaft 18d can further include an agitator follower 18e further comprising a U-shaped opening. A gate 19 (not shown in the figures to facilitate viewing of the fan blade assembly 10) is moveable by a user between an open position and a closed position. Many commonly known ways to move the gate 19 exist, including, but not limited to, physically directly moving gate; using a lever or knob to move the gate; using a push/pull cable to move the gate; employing an electronic actuator to move the gate; and so forth. In the closed position, the openings in the gate 19 do not line up with the openings 18, and granular material remains in the hopper 17. In the open position, the openings in the gate 19 line up with the openings 18, and granular material in the hopper 17 can flow past the gate 19 and out the openings 18 onto a fan 20, which rotates, for distribution of the granular material onto a ground surface, as will be described below.

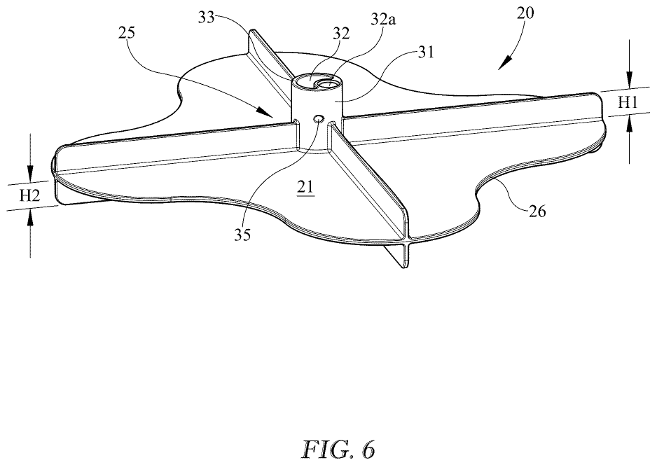

With particular reference to FIGS. 2, 5, and 6, the fan 20 is a generally planar structure having a central region 25 and an outer perimeter 26 that, overall, assumes a generally disc-like overall shape surrounding the central region 25. Generally speaking, the disc-like shape extends radially outwardly from the central region 25, and a fan axis of rotation FA lies within the central region 25, and in particular lies coincident with the shaft axis of rotation SA that extends through the central region 25. This is not to say the fan 20 must be a disc having an outer perimeter that is a circle, when viewed from above. A circular shape, when viewed from above, is certainly possible, but the outer perimeter can assume any number of shapes when viewed from above. As non-limiting examples, the outer perimeter, when viewed from above, in addition to circular, can by any polygonal shape (e.g., triangular, rectangular, pentagonal, hexagonal, any simple or complex n-gonal, any regular or irregular n-gonal, and any concave or convex n-gonal shape, etc.). The outer perimeter also can assume an irregular shape, both irregular angular as well as irregular smooth (e.g., lobular). Additionally, the outer perimeter can be non-rotationally symmetric about the center of the fan. Basically any substantially planar disc-like shape can serve as the generic shape of the fan 20. For simplicity, all the figures depict a fan 20 having the same overall shape, namely a four-lobe lobular disc-like shape.

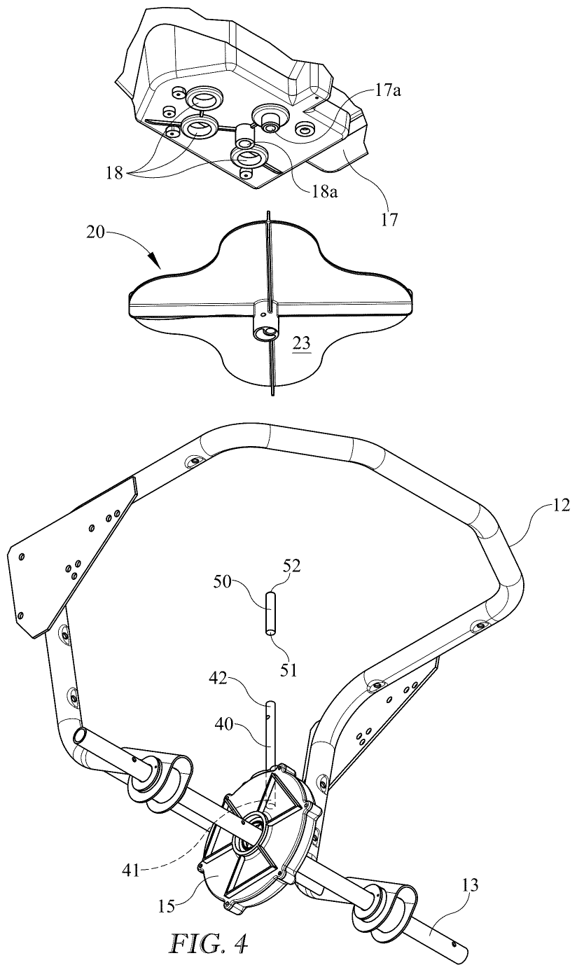

With general reference to FIGS. 2-6, the central region 25 of the fan 20 is typically structurally reinforced or thickened to provide structural integrity to the fan 20 and also to provide the structure needed for receiving a shaft, as will be described below. In the embodiment shown in the figures, the central region 25 includes a shaft boss 30. The shaft boss 30 is a substantially right cylindrical body having a first end 33 and a second end 34 defining a length L of the shaft boss 30. The shaft boss 30 also includes an outer surface 31 and one or more inner surfaces 32. One of the inner surfaces 32 (or, in embodiments having only a single inner surface 32, then the inner surface) is a shaft opening 32a configured to receive therewithin a shaft, as will be described.

The shaft boss 30 is configured to be removably coupled to the first shaft 40. Various means for coupling the first shaft 40 to the shaft boss 30 are possible, including, but not limited to, using a hole through each of the shaft boss 30 and the first shaft 40 that can receiving a locking pin; using a key that is insertable into slots in each of the shaft boss 30 and first shaft 40; using some other form of mating structure that can be received in a portion of each of the shaft boss 30 and first shaft 40; and the like. As used herein, such coupling of the first shaft 40 to the shaft boss 30 is generically referred to as “locking” or “coupling” or “mating” or “securing”, etc., one to the other. In general, items such as a locking pin, a key, or any mating structure, etc., in a similar fashion as described for other locks described below, is generically referred to as a lock, and the structure to which the lock is coupled is generically referred to as a receiver, it being understood that these terms are not intended to be limited to a pin and a hole, per se. Rather, the locking structure can be generically referred to as a lock and a receiver. For the sake of simplicity, however, in the figures, one embodiment of such a lock is depicted, namely a locking pin 60 that is insertable through a pin-receiving hole 35 in the shaft boss 30 and a pin-receiving hole 43 in the first shaft 40. The one or more pin-receiving holes 35 are present that extend through the outer surface 31 and the inner surface 32/32a. The pin-receiving hole 35 is configured to receive therethrough a locking pin 60 that physically couples the shaft to the shaft boss 30, as will be described.

Referring again to FIGS. 2-6, the fan 20 includes a first side 21 and a second side 23. On the first side 21 is one or more first appurtenance 22. The first appurtenance 22 can be generally described as a feature that has a length generally in a radial direction along the first side 21 and has a height H1 that extends away from the first side 21 in a direction parallel to the fan axis of rotation FA. The first appurtenance 22 can assume various shapes and can have various lengths, widths, and heights. The first appurtenance 22 can be linear, substantially linear, curvate, alternating linear and curvate, angled, continuous, intermittent, and the like. In general, the first appurtenance 22 serves to facilitate the distribution onto a ground surface of the granular material that flows from the openings 18 of the hopper 17 and onto the first side 21 of the fan 20.

Advantageously, the fan 20 according to embodiments herein also includes a second side 23 that includes one or more second appurtenance 24. The second appurtenance 24 can be generally described as a feature that has a length generally in a radial direction along the second side 23 and has a height H2 that extends away from the second side 23 in a direction parallel to the fan axis of rotation FA. The second appurtenance 24 can assume various shapes and can have various lengths, widths, and heights. The second appurtenance 24 can be linear, substantially linear, curvate, alternating linear and curvate, angled, continuous, intermittent, and the like. In general, the second appurtenance 24 serves to facilitate the distribution onto a ground surface of the granular material that flows from the openings 18 of the hopper 17 and onto the second side 23 of the fan 20. The height H1 of the first appurtenance 22 and the height H2 of the second appurtenance 24 can be the same or can differ

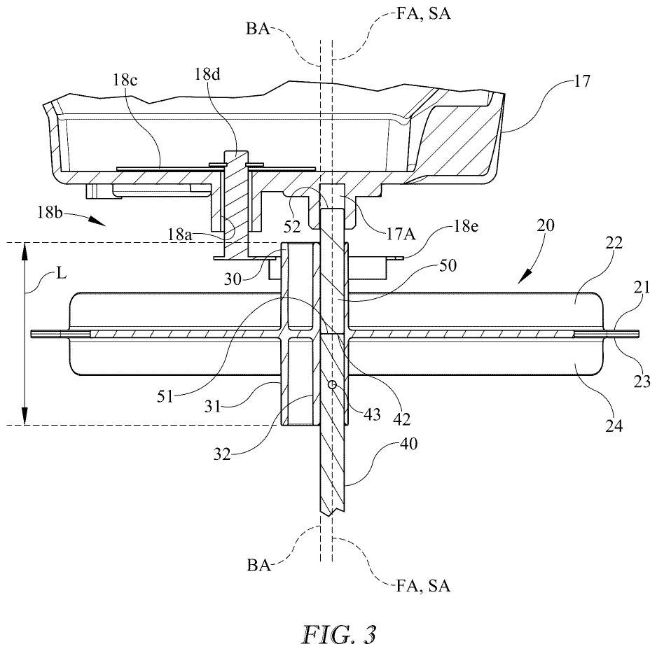

Referring again to FIGS. 3, 5, and 6, the shaft boss 30 of the embodiment depicted includes two inner surfaces 32. The shaft opening 32a is offset from the central longitudinal axis BA of the shaft boss 30, which obviously resides at the center of the cylindrical body that is the shaft boss 30. In FIG. 3 the central longitudinal axis BA is most easily visible. The shaft opening 32a receives the first shaft 40, which rotates about its shaft axis SA. Because the first shaft 40 is coupled to the shaft boss 30 via pin-receiving hole 35 and locking pin 60, as the first shaft 40 rotates (as a result of the gearbox 15) about its shaft axis SA, so too does the fan 20 rotate about the shaft axis SA, which is coincident with the fan axis of rotation FA. And, because the shaft opening 32a is offset from the central longitudinal axis BA of the shaft boss 30, thus acting like a cam and causing the outer surface 31 of the shaft boss 30 to traverse an eccentric motion as the shaft boss 30 rotates about the shaft axis SA. This eccentric motion of the outer surface 31 is utilized by the agitator assembly 18b, if one is included. In such embodiments, the outer surface 31 of the shaft boss 30 is received within the U-shaped opening of the agitator follower 18e. Thus, as the eccentric motion of the outer surface 31 rotates within the agitator follower 18e, the agitator follower 18e rotates the agitator shaft 18d back and forth, which moves the agitator arm 18c back and forth. This agitates the material around the hopper openings 18 to prevent bridging of the granular material and to promote better flow of material through the hopper openings 18.

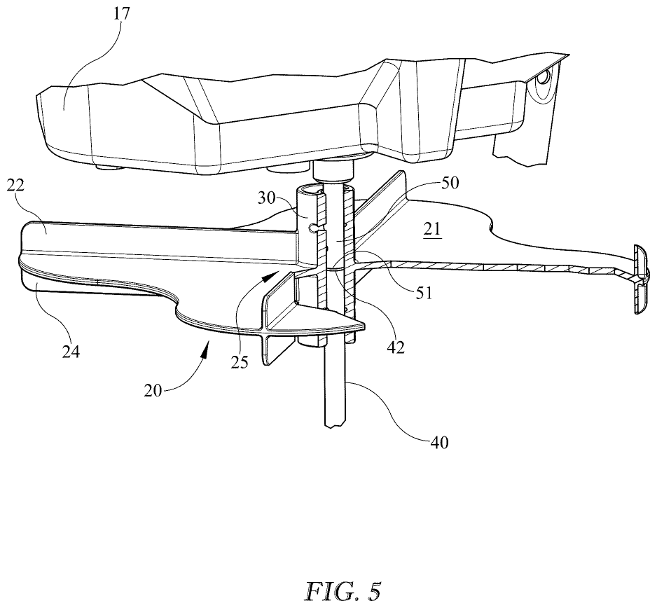

With continued reference to FIGS. 3 and 5, the fan blade assembly of this embodiment includes a second shaft 50. The second shaft 50 includes a first end 51 and a second end 52. Ideally, the outer diameter of the second shaft 50 is equal to the outer diameter of the first shaft 40. The second shaft 50 is a floating shaft, that is, it is not fixedly coupled to the gearbox 15, nor is it fixedly coupled to any structure within the hopper 17. Instead, the first end 51 of the second shaft 50 is configured to be inserted into the top portion of the shaft opening 32a, and the second end 52 is configured to be inserted into an opening 17a in the bottom of the hopper 17. The presence of a floating second shaft 50 enables the fan blade assembly 10 to be easily disassembled and reassembled, and thereby provides an easy way to reverse the fan 20 in order to extend its service life.

The relative lengths of the first shaft 40 and second shaft 50, as well as the length L of the shaft boss 30, coupled with the relative spacing between the gearbox 15 and the bottom of the hopper 17 cooperate to enable the easy disassembly and reassembly of the fan blade assembly 10.

### Assembly and Use

As stated, a significant benefit of the fan blade assembly 10 according to the various embodiments herein is that the assembly 10 can be easily disassembled, the fan 20 can be flipped over 180 degrees, and the assembly 10 reassembled in very little time. Having a fan 20 with both sides being configured to receive and disperse granular material flowing from the hopper 17 significantly increases the service life of the fan 20, which additionally saves the user money over the life of the spreader 11.

During initial assembly, the axle 13 is rotated so as to move the first shaft 40, with its first end 41 connected to the gearbox 15, in a direction away from the handle 16 to provide space for installing the fan 20. The fan 20 is placed over the second end 42 of the first shaft 40 and oriented such that the first side 21 faces away from the gearbox 15. The second end 42 of the first shaft 40 is inserted into the shaft opening 32a by first entering from the second end 34 toward the first end 33. The fan 20 is pushed onto the first shaft 40 until the first shaft 40 extends through at least a majority of the length of the shaft opening 32a.

Next, a user then places the second shaft 50 into the opening 17a in the bottom of the hopper 17 by first inserting the second end 52 into the opening 17a in the bottom of the hopper 17. While the second end 52 of the second shaft 50 is being held in the opening 17a, the fan 20 is brought into proximity with the second shaft 50 by moving the first shaft 40 (with the fan 20 coupled thereto) toward the second shaft 50. The fan 20 is moved into position such that the first shaft 40 and the second shaft 50 align. Then, the first end 51 of the second shaft 50 is inserted into the top portion of the shaft opening 32a above and collinear with the first shaft 40. Once the first shaft 40 and the second shaft 50 are aligned and partially contained within the shaft opening 32a, the fan 20 is moved upwardly toward the hopper 17. As this upward movement is occurring, the agitator follower 18e (if present) is oriented so as to accept the outer surface 31 of the shaft boss 30 between the U-shaped opening of the agitator follower 18e. When the agitator follower 18e is properly oriented to accept the outer surface 31 of the shaft boss 30, the fan 20 can continue to be moved upwardly toward the hopper 17. This continued upward movement occurs until the pin-receiving hole 35 in the shaft boss aligns with the pin-receiving hole 43 in the first shaft 40. Once aligned, a locking pin 60 is inserted through the pin-receiving hole 43 to directly couple the first shaft 40 to the shaft boss 30 (and thereby, the fan 20). In this configuration, the first side 21 of the fan is facing the hopper 17, and granular material that flows from the openings 18 of the hopper 17 will drop onto the first side 21 of the fan 20.

The second shaft 50 of this embodiment has a length that enables it to fit within the hopper opening 17a and extend into a portion of the shaft opening 32a while the second end 42 of the first shaft 40 is also resident within the shaft opening 32a. That is, the second shaft 50 fits between the hopper 17 and the second end 42 of the first shaft 40, but must be long enough so as to not slip out of either the hopper opening 17a or the shaft opening 32a in use. Therefore, the length of the second shaft 50 depends in part on the relative dimensions of the space between the hopper 17 and the gearbox 15; the length of the first shaft 40; the desired distance between the fan 20 and the openings 18; and the length L of the shaft boss 30. The farther apart the fan 20 is desired to be from the openings 18, the longer the second shaft 50. Similarly, the length of the first shaft 40 is preferably dimensioned so that the fan 20 can slide down the first shaft 40 to reveal the meeting location of the first shaft 40 and second shaft 50 within the shaft opening 32a to enable rotating the first shaft 40 away from the hopper 17 for assembly/disassembly of the fan blade assembly 10. The shaft boss length L depends in part on the relative lengths of the first shaft 40 and second shaft 50 that is desired to be housed within the shaft opening 32a of the shaft boss 30 in order to maintain structural integrity of the fan blade assembly 10 during use. The shaft boss length L also depends in part on the structural strength of the material that makes up the fan 20 and the shaft boss 30. Basically, enough length of each of first shaft 40 and second shaft 50 is desired to be within the shaft opening 32a so as to not allow the second shaft 50 from coming apart from the shaft boss 30 (since, as described above, the second shaft 50 is a floating shaft). In many respects the shaft boss length L can take on nearly any desirable length, but typically will be between approximately ½ inch and approximately 12 inches, and preferably will be between approximately 1 inch and approximately 8 inches, and most preferably will be between approximately 1-⅜ inch and approximately 3 inches.

Now, the spreader 11 can be operated to spread granular material onto a ground surface. Once granular material is placed into the hopper 17, a user can move the spreader 11 across a ground surface. As the wheels 14 traverse across the ground, the axle 13 turns with the wheels 14. This rotation of the axle 13 is converted into rotation of the first shaft 40 by the gearbox 15. The first shaft 40 rotates about the shaft axis of rotation SA. Because the first shaft 40 is coupled to the fan 20 via locking pin 60, the fan 20 rotates in unison with the first shaft 40. As the fan 20 rotates about the fan axis of rotation FA, which coincides with the shaft axis of rotation SA, the outer surface 31 of the shaft boss 30 rotates with the first shaft 40. And, as discussed above, because the first shaft 40 is offset from the central longitudinal axis BA of the shaft boss 30, the outer surface 31 traverses an eccentric path as it rotates. The agitator follower 18e (if included) alternates in a back-and-forth motion as the outer surface 31 eccentrically moves within the U-shaped opening of the agitator follower 18e. This action moves the agitator arm 18c back-and-forth to minimize the formation of dams or blockages of material within the hopper 17. The first appurtenances 22, as the fan 20 rotates, facilitate the spreading of the granular material onto the ground as the spreader 11 moves across the ground.

As stated above, the repeated use of spreaders such as spreader 11 can, over time, wear out the first surface 21 and/or the first appurtenances 22. If the wear damage becomes great enough, the fan 20 is no longer desirable as a means for spreading granular material. Advantageously, the fan blade assembly 10 provides a quick, easy, low-cost solution to reinstating the usability of the spreader 11. Because of the floating second shaft 50 and the reversible fan 20, repairing the spreader 11 is easy. All the user has to do is remove the fan 20, flip it over, and reinstall the fan 20.

To remove the fan 20, the above assembly steps are basically performed in reverse order. First, the locking pin 60 is removed from the pin-receiving hole 43. Then, the fan 20 is pushed downwardly onto the first shaft 40 far enough until the second shaft 50 has enough room to be removed from the opening 17a and the shaft opening 32a. Once the second shaft 50 is removed, the fan 20 can be removed from the first shaft 40 by lifting the fan 20 until the first shaft 40 exits from the second end 34 of the shaft boss 30. This completely separates the fan 20 from the first shaft 40. Now, the fan 20 is flipped 180 degrees so that the second side 23 of the fan 20 faces the hopper 17. The fan 20 is then installed in this orientation onto the first shaft 40, as described above for the initial assembly. The second shaft 50 is inserted into the opening 17a and the shaft opening 32a as described above. The fan is rotated and aligned so as to properly place the agitator follower 18e (if included) around the outer surface 31 of the shaft boss 30, and the locking pin 60 is inserted into the pin-receiving hole 43. Now the spreader 11 is useable again, with the second side 23 being the surface onto which granular material can flow for spreading, without the need for buying a new fan 20.

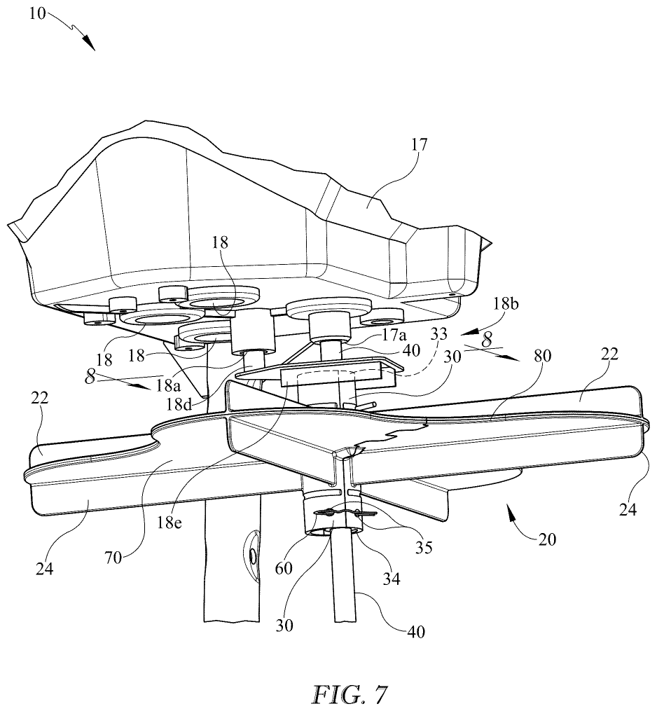

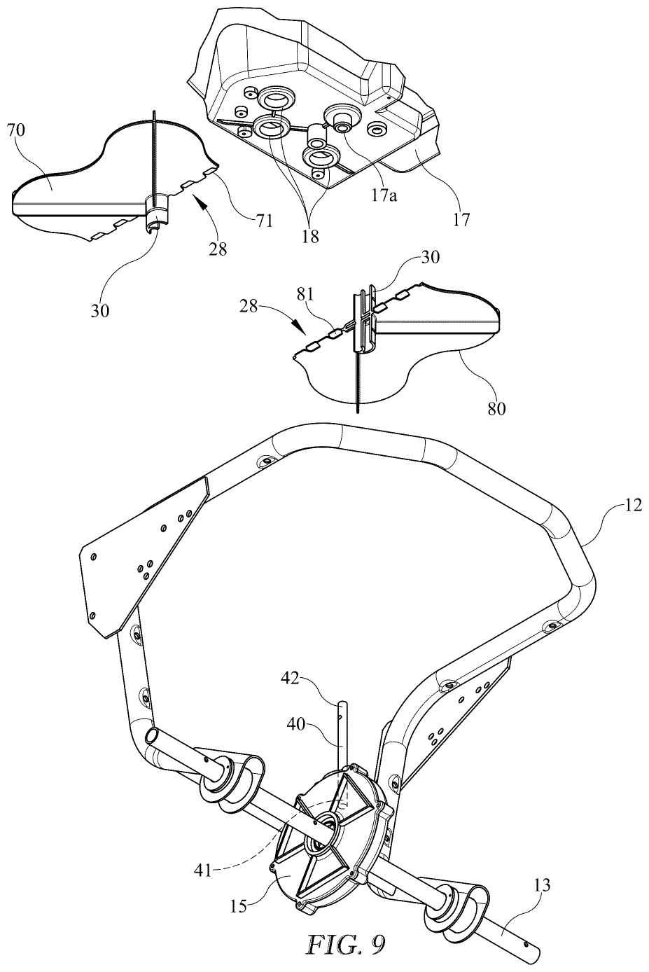

FIGS. 7-10 depict an alternative embodiment in which the fan blade assembly 10 similarly includes a fan 20 having a first side 21 with first appurtenances 22 and a second side 23 with second appurtenances 24. The fan 20 also can be used with the first side 21 facing the hopper 17. Then, after substantial wear to the first side 21, the fan 20 can be removed from the spreader 11, flipped over 180 degrees, and reinstalled so that the second side 23 is facing the hopper 17.

In this embodiment, the fan 20 includes two or more fan partial bodies 27 that each include a mating structure 28 for coupling together. In the embodiment depicted in these figures, there are two fan partial bodies 27, but it is possible to have more than two fan partial bodies 27. As shown, the fan partial bodies 27 include a first fan partial body 70 and a second fan partial body 80. The fan partial bodies are separable along a joint. In the embodiment shown in the figures, the joint goes through the shaft boss 30, such that a portion of the shaft boss 30 is part of first fan partial body 70 and another portion of the shaft boss 30 is part of the second fan partial body 80. However, it is possible that the joint does not go through the shaft boss 30, such that the shaft boss 30 resides completely on one fan partial body (e.g., first fan partial body 70). Each fan partial body includes a portion of the shaft boss 30

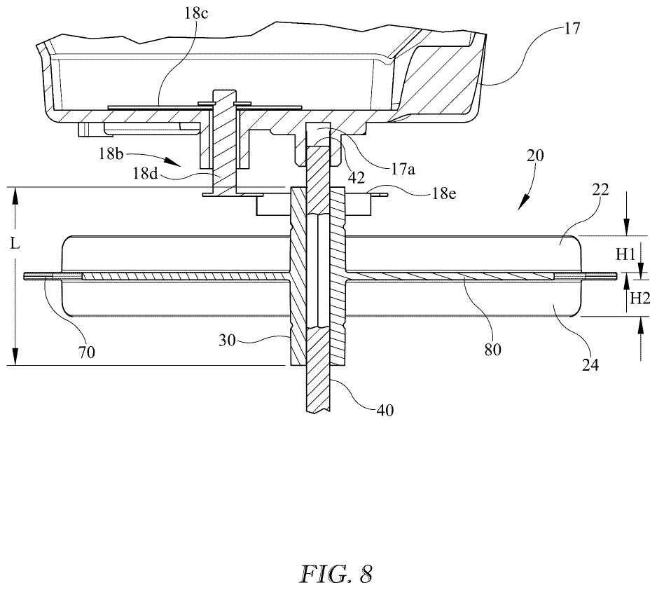

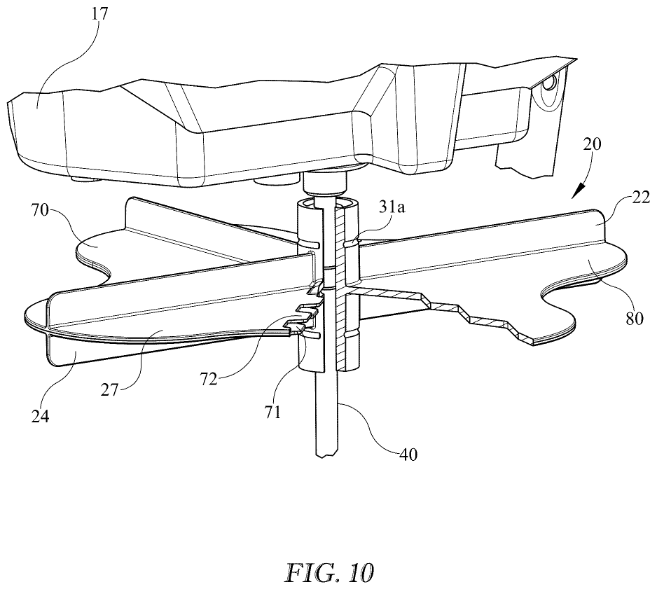

With reference to FIGS. 8-10, the first fan partial body 70 includes a first mating structure 71 located along an edge of the first fan partial body 70. The mating structure 71 can be of any type of mating structure that is able to be releasably coupled to a complementary mating structure on a secondary piece, such that once the mating structure 71 is engaged, the two pieces that include the mating structure 71 are coupled together as a single piece, and once the mating structure 71 is disengaged, the two pieces that include the mating structure 71 are separated into pieces. Therefore, those of ordinary skill in the art can easily utilize various different types of mating structure 71 for the purpose of releasably coupling the first fan partial body 70 with the second fan partial body 80. For the sake of simplicity in the figures, the embodiment shown depicts first mating structure 71 as including a series of alternating tabs 72. Similarly, the second mating structure 81 includes a complementary series of alternating tabs 82. The alternating tabs 72, 82 are complementary, such that the alternating tabs 72 can be inserted into and structurally received by alternating tabs 82. Once the complementary tabs are engaged, the two fan partial bodies make up a singular fan 20. To secure the fan 20 as a single fan, a lock of some form is used. In this context, similar to that described above regarding the locking pin 60, the locking structure can be of any number of locking structures that can couple multiple pieces together as one. Examples include, but are not limited to, a locking pin that physically surrounds a portion of the fan partial body 70 and fan partial body 80; a mating structure having complementary features on each of the fan partial body 70 and fan partial body 80; a key in a slot; any other form of geometric complementary features; any form of pin that goes through any portion of the fan partial body 70 and fan partial body 80 (such as, e.g., cotter pins, rings, extended prong pins; R-clips; hammer lock pins, and so forth). For the sake of simplicity, however, in the figures, a particular type of lock is depicted, namely a locking pin 90 is shown. As stated, various types of locking pins are possible to keep the first fan partial body 70 and the second fan partial body 80 together as a unit, but for simplicity, the embodiment shown in the figures is a spring clip-type cotter pin that surrounds the two fan partial bodies at the shaft boss 30. In particular, as seen in FIG. 10, the locking pin 90 is forced (against the spring force of the locking pin 90) into a groove 31a on the outer surface 31 of the shaft boss 30. Once the locking pin 90 is inserted in the groove 31a, the two fan partial bodies are joined together to render fan 20 a singular item.

Use of the fan 20 according to this embodiment eliminates the need for second shaft 50. As shown in FIGS. 7 and 8, first shaft 40 extends from the gearbox 15 to the opening 17a in the hopper 17. Thus, in this embodiment, to remove the fan 20, flip it over 180 degrees, and reinstall the fan 20, all that is required is to separate the first fan partial body 70 from the second fan partial body 80. For initial assembly, the process involves placing first fan partial body 70 alongside first shaft 40 with the first side 21 facing the hopper 17. Then, the user places second fan partial body 80 also alongside first shaft 40, such that first shaft 40 now is within shaft opening 32a. The user then couples the first fan partial body 70 to the second fan partial body 80 by engaging mating alternating tabs 72, 82. Once engaged, the user can secure the assembly by inserting locking pin 90 into groove 31a. The user can slide the assembly up or down first shaft 40 until pin-receiving hole 35 aligns with pin-receiving hole 43. Then, the user can insert locking pin 60 through pin-receiving hole 43. The fan blade assembly 10 is now ready for operation, and granular material flowing from the hopper 17 will impact first side 21 of fan 20.

When it is time for a user to reverse the fan 20 (as described, for example, if first side 21 and/or first appurtenances 22 become worn), the user can do this very simply. The user removes locking pin 60 from pin-receiving hole 43. This enables the fan 20 to slide along first shaft 40. The user removes locking pin 90 from groove 31a, which facilitates the separate of first fan partial body 70 from second fan partial body 80. The user applies force to separate the two fan partial bodies by disengaging first mating structure 71 from second mating structure 81. In the embodiment shown, this means disengaging alternating tabs 72 from alternating tabs 82. Now the fan 20 comprises two separate pieces. The user can then flip the fan 20 180 degrees so that second side 23 of one or both of first fan partial body 70 and second fan partial body 80 faces the hopper 17. With second side 23 now facing the hopper 17, the user can re-install the fan 20 into the spreader 11 using the steps described above. Once completed, now the fan 20 is ready for service again, without the need to purchase an entire new fan 20.

While several embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, embodiments may be practiced otherwise than as specifically described and claimed. Embodiments of the present disclosure are directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

It is to be understood that the embodiments are not limited in its application to the details of construction and the arrangement of components set forth in the description or illustrated in the drawings. The invention is capable of other embodiments and of being practiced or of being carried out in various ways. Unless limited otherwise, the terms “connected,” “coupled,” “in communication with,” and “mounted,” and variations thereof herein are used broadly and encompass direct and indirect connections, couplings, and mountings. In addition, the terms “connected” and “coupled” and variations thereof are not restricted to physical or mechanical connections or couplings.

The foregoing description of several embodiments of the invention has been presented for purposes of illustration. It is not intended to be exhaustive or to limit the invention to the precise steps and/or forms disclosed, and obviously many modifications and variations are possible in light of the above teaching.

What is claimed is:

1. A fan blade assembly comprising:
a fan having a central region, a first side, and a second side, wherein said first side includes one or more appurtenances thereon extending away from said first side, and wherein said second side includes one or more appurtenances thereon extending away from said second side;
a shaft boss located at said central region of said fan, said shaft boss having a generally cylindrical shape with a length between a first end of said shaft boss and a second end of said shaft boss, an outer surface and a shaft opening therein, said shaft opening being configured to receive therewithin one or more shafts;
a first shaft having a first end and a second end, said first end being coupled within a gearbox and said second end configured to be disposed within said shaft opening.

2. The fan blade assembly of claim 1, wherein said first appurtenance further comprises one or more ribs extending from near said shaft boss toward an outer perimeter of said first side.

3. The fan blade assembly of claim 1, wherein said second appurtenance further comprises one or more ribs extending from near said shaft boss toward an outer perimeter of said second side.

4. The fan blade assembly of claim 1, wherein said second end of said first shaft is disposed within said shaft boss between said first end of said shaft boss and said second end of said shaft boss.

5. The fan blade assembly of claim 4, further comprising a second shaft having a first end and a second end.

6. The fan blade assembly of claim 5, wherein said first end of said second shaft is configured to be disposed within said shaft boss between said first end of said shaft boss and said second end of said shaft boss, above said second end of said first shaft.

7. The fan blade assembly of claim 6, wherein said second end of said second shaft is configured to be disposed within a housing of a hopper of a broadcast spreader.

8. The fan blade assembly of claim 7, wherein said shaft boss length is between approximately one inch and approximately twelve inches.

9. The fan blade assembly of claim 1, wherein said shaft boss further comprises a receiver disposed radially through said shaft boss.

10. The fan blade assembly of claim 9, wherein said first shaft further comprises a receiver disposed radially through said first shaft along a length of said first shaft.

11. The fan blade assembly of claim 10, wherein said receiver in said first shaft is configured to be selectively positioned to coincide with said receiver of said shaft boss to receive a lock therethrough.

12. The fan blade assembly of claim 1, wherein said first shaft extends through said shaft boss, and said second end of said first shaft is configured to be disposed with a housing of a hopper of a broadcast spreader.

13. The fan blade assembly of claim 12, wherein said fan further comprises at least two separable fan partial bodies.

14. The fan blade assembly of claim 13 wherein each of said at least two separable fan partial bodies further comprise mating structures for selectively joining said at least two separable fan partial bodies together.

15. The fan blade assembly of claim 14, wherein said at least two separable fan partial bodies are separable through at least a portion of said shaft boss.

16. The fan blade assembly of claim 15, wherein said at least two separable fan partial bodies are configured to be coupled together with a lock.

17. A fan blade assembly comprising:
a fan having a central region, a first side, and a second side, wherein said first side includes one or more appurtenances thereon extending away from said first side, and wherein said second side includes one or more appurtenances thereon extending away from said second side;
a first shaft having a first end and a second end, said first end being coupled within a gearbox;
a second shaft having a first end and a second end, said second end of said second shaft being configured to be freely received within a hopper of a spreader;
a shaft boss located at said central region of said fan, said shaft boss having a generally cylindrical shape with a length between a first end of said shaft boss and a second end of said shaft boss, an outer surface and a shaft opening therein;
wherein said shaft opening is configured to receive therewithin said second end of said first shaft, and to receive said first end of said second shaft collinear with said first shaft; and
a lock configured to couple said first shaft to said shaft boss.

18. The fan blade assembly of claim 17, wherein said first appurtenance further comprises one or more ribs extending from near said shaft boss toward an outer perimeter of said first side.

19. The fan blade assembly of claim 17, wherein said second appurtenance further comprises one or more ribs extending from near said shaft boss toward an outer perimeter of said second side.

20. A method of reconfiguring a fan blade of a broadcast spreader, said method comprising the steps of:
providing said broadcast spreader with a fan blade assembly further comprising a fan having a first side, a second side, and a shaft boss in a central region thereof, wherein said shaft boss further comprises a shaft boss receiver; and a shaft having a receiver therein configured to receive a lock for securing said fan to said shaft; wherein said fan first side includes one or more first appurtenances and said fan second side includes one or more second appurtenances, and wherein said fan first side is facing a first direction;
removing said fan from said shaft by removing said lock from said receiver;
separating said fan from said shaft;
flipping said fan 180 degrees so as to make said fan first side face in a second direction opposite said first direction;
inserting said shaft into said shaft boss of said fan;
aligning said receiver of said shaft with said shaft boss receiver; and
inserting said lock into said receiver of said shaft boss through said receiver of said shaft.
